(19) United States
(12) Patent Application Publication
(10) Pub. No.: US 2014/0324299 A1
(43) Pub. Date: Oct. 30, 2014

(54) VEHICLE, A BOAT OR AN AIRPLANE COMPRISING A CLOSED COMPARTMENT, A MULTIMEDIA INFORMATION SOURCE AND A CONTROL SYSTEM

(71) Applicant: Bang & Olufsen A/S, Struer (DK)

(72) Inventor: Bjarne Sørensen, Thyholm (DK)

(21) Appl. No.: 14/359,763

(22) PCT Filed: Nov. 22, 2012
(86) PCT No.: PCT/EP2012/073378

§ 371 Date: May 21, 2014

(30) Foreign Application Priority Data
Nov. 22, 2011 (DK) PA 2011 00915 22
Nov. 23, 2011 (DK) PA 2011 00917 23

(51) Int. Cl. B60R 16/037; B64D 11/00

(52) U.S. Cl. CPC B60R 16/037; B64D 11/0015; B64D 2011/0038; H04L 2012/40267
USPC 701/49; 701/36

(57) ABSTRACT

A vehicle, a boat or an airplane with a closed compartment and an integrated control system to be applied in the closed compartment, the control system having included access to data and control of: Internet multimedia information sources, local server resident multimedia information sources, light sources (e.g. lamp & daylight), comfort equipment (e.g. chair), one or more sound providers (loudspeakers), one or more video providers (screens). The system operates in a plurality of scene modes, each of which is established by a single/one activation via an interactive man-machine-device (e.g. iPad).

The present invention relates to a vehicle, a boat or an airplane comprising a closed compartment, a multimedia information source and a control system, the compartment having both multimedia providing equipment and comfort equipment, such as dimmable windows and controllable seats, and where different modes or scenes are defined by parameters for the individual equipment elements. Thus, changing from one mode/scene to another requires only a single instruction.

In the prior art standard, utilities are implemented in closed compartments. In a car, for example, controllable features may be: cabin temperature, optionally per zone, air condition, sun roof open/close, heating in seats, adjustable seats, internal lights, external mirrors, door locks, AV systems, loudspeakers, navigation system, on screen display, window blinds and etc.

All these features may be controlled individually, but in some cars a simple coding of the different selections and parameter settings may be saved per individual user. Traditionally, these alternative settings are allocated to a specific key, e.g. one key per user. Upon entering the car, the actual key in use addresses the set of settings to be established accordingly.

The invention discloses an integrated system in which standard utilities are configured into individual modes of operation and with related parameter settings according to the actual user and the user's desire for a given mode of operating, e.g. to work or to relax.

A first aspect of the invention relates to a vehicle, a boat or an airplane comprising a closed compartment, a multimedia information source and a control system, wherein:
the closed compartment comprises:
   controllable light sources,
   controllable comfort equipment,
   one or more sound providers and
   one or more video providers,
the control system comprises a control device configured to receive an instruction and output controlling information to the light sources, the comfort equipment, the sound provider(s) and the video provider(s), the instruction identifying a set of a plurality of sets, each set comprising a setting for the controllable light sources, the controllable comfort equipment, the one or more sound providers and the one or more video providers.

Typically, an iPhone, iPod Touch or an iPad may be useful as the control device.

For example, the iPhone can operate and control: select sets/scene modes, control volume settings and system stand by. As another example, the iPad can operate and control: lights settings, seats and curtains and select and control movies and music to be provided and further search and access to the Internet.

It is preferred that the system is connected to the Internet and other local networks in the closed compartment; this environment e.g. being a car. Connection to the Internet is via wireless routers. Thus, in one embodiment, the control system is configured to connect to the internet.

The control system and means for system operation are all preferably connected according to the actual functional requirements and networks available at the compartment.

For ease of use and in comfort of the user different operational modes or sets are defined. The sets/modes are preferably named “Scene modes”, and each of these offer a specific functionality to the user. In other words, a comfort zone may be established for the user, and the available functionalities adapted to the actual situation required by the user e.g. the work situation or the relax situation. Thus, the environmental conditions are adjusted according the activity situation, e.g. work or relax.

To support control in each of the sets, dedicated applications may be made available, one per set. These applications are also known as “Apps” that may be downloaded into the control device/smart phone, e.g. into an iPad.

When a spoken command interface is supported, commands to control the set shift are simply that the user speaks the name of the set to be the next active set, e.g. “Office”.

Supplemental scene modes, i.e. other than those specifically disclosed in this document, may be defined as required in alternative applications. This includes modes/sets including parameter settings defined on settings for prior art standard utilities.

In the description below, the equipment referred to as “Lens” is an acoustical lens, which acts as a sound reflector, to optimize the distribution of sound in a closed compartment.

In one embodiment, the controllable light sources comprises one or more of: a cabin light, a roof light, ambient light, loudspeaker light and subwoofer light.

In one embodiment, the controllable comfort equipment comprises one or more of: a front window with controllable tinting, one or more side windows with controllable tinting, controllable curtains, and one or more seats with controllable settings.

In one embodiment, the one or more sound providers comprises: an audio provider, one or more loudspeakers and one or more subwoofers.

In one embodiment, the one or more video providers comprises one or more TV screens.

In one embodiment, the control device comprises one or more of the group consisting of: a physical push button, a touch sensitive area on a physical device, a gesture sensitive device, and a pointing device.

A set or scene mode is entered via user activation on the control device preferably being an interactive man-machine-device, the control device comprising e.g. a physical push button, a touch sensitive area on a physical device, or a gesture sensitive device.

Alternatively, commands, or supplemental commands, may be entered via spoken commands, or via pointing devices supporting wireless technologies like RF and infrared light or laser. Thus, the control device may be configured to receive, as the instruction, a spoken command.

The user activation preferably is a single event as the trigger of one or more events that brings the system from a current set mode to a new set and correspondingly establishes all the settings related to the new set.

In one embodiment, the compartment comprises one or more controllable seats, a front window with a controllable tinting, one or more side windows with controllable tinting, a controllable cabin light, a controllable roof light, controllable ambient light, one or more loudspeakers each comprising an acoustical lens with controllable illumination, a TV screen movable between an active and an inactive position, and a sub-woofer movable between an active and an inactive position and with a controllable illumination.

Then, in one situation, one set comprises the following parameters:
front window tinting: 100%,
side window tinting: 50%,
seats are adjusted to a first pre-adjusted setting,
cabin light intensity: 100%,
roof light: maximum illumination,
ambient light intensity: maximum illumination,
lens light intensity: maximum illumination,
TV screen: active position,
sub-woofer: inactive position,
sub-woofer light intensity: off.

In this mode, a work environment is established, with settings optimized for the work situation.

The interior light and windows is transformed or set to an office scene in a smooth and well-balanced way. The sound setting is set to have the Centre sound image in front of the TV screen.

The iPad app starts up and changes rapidly to the Office scene control, as the iPad automatically has registered that the system is in the Office scene mode.

Further functional aspects are relevant in this mode:
The system supports single user operation or two users via a split screen.
Video conference including split screen with presentation and conference.
Go through presentations via an iPad.
Go through budget in an Excel sheet via a laptop or an iPad.
Read mail via an iPad.

In another situation, one set comprises the following parameters:
front window tinting: 33%,
side window tinting: 33%,
seats are adjusted to a second pre-adjusted setting,
cabin light intensity: 40%,
roof light: minimum illumination,
ambient light intensity: maximum illumination,
lens light intensity: maximum illumination,
TV screen: active position,
sub-woofer: active position,
sub-woofer light intensity: maximum illumination.

In this mode, a sound studio environment is established, with settings optimized for the music listening situation.

Last played music may start to play at a stored volume setting and a mini player application in the top menu on the iPad may show the cover art for the actual piece of music played back.

By use of the volume control on the iPad the user can adjust the volume simply by touching the + or − icons on the iPad. After activating the volume control the user can also use the volume bar for rapid volume adjustments.

The volume may be turned up by activating the + icon on the iPad and turned down again by pressing the mid position on volume bar. Afterwards, the mute and de-mute function may be shown by pressing the mute icon twice with a little delay in between.

In yet another situation, one set comprises the following parameters:
front window tinting: 100%,
side window tinting: 100%,
seats are adjusted to a third pre-adjusted setting,
cabin light intensity: 10%,
roof light: minimum illumination,
ambient light intensity: 10% illumination,
lens light intensity: low illumination,
TV screen: active position,
sub-woofer: active position,
sub-woofer light intensity: 10% illumination.

In this mode, a video studio environment is established, with settings optimized for the movie viewing situation.

Seats may be adjusted to show possibilities, such as massage + back support.

In another situation, one set comprises the following parameters:
front window tinting: 0%,
side window tinting: 70%,
seats are adjusted to a third pre-adjusted setting,
cabin light intensity: 60%,
roof light: maximum illumination,
ambient light intensity: 50% illumination,
lens light intensity: high illumination,
TV screen: inactive position,
sub-woofer: active position,
sub-woofer light intensity: 50% illumination.

In this mode, a default environment is established, with settings optimized for the general situation e.g. just for driving.

In yet another situation, one set comprises the following parameters:
front window tinting: 100%,
side window tinting: 100%,
seats are adjusted to a fourth pre-adjusted setting,
cabin light intensity: 100%,
roof light: off,
ambient light intensity: 100% illumination,
lens light intensity: high illumination,
TV screen: active position,
sub-woofer: active position,
sub-woofer light intensity: 100% illumination.

In this mode, an effective internet access environment is established, with settings optimized for the browsing and exploring situation.

The Internet browser may be started on a user specified default webpage.

A selected game may appear on the iPad and/or be active to be run on the TV.

Yet another situation may be one in which a set comprises the following parameters:
front window tinting: 100%,
side window tinting: 100%,
seats are adjusted to a fifth pre-adjusted setting,
cabin light intensity: 33%,
roof light: minimum illumination,
ambient light intensity: 33% illumination,
lens light intensity: high illumination,
TV screen: active position,
sub-woofer: inactive position,
sub-woofer light intensity: off.

In this mode, a comfort environment is established, with settings optimized for the relaxing situation.

A slideshow with photos stored on the media center may be started or resumed.

The user can easily connect any USB storage device to the system and copy photos or other files to the media center.

Other or additional features may be available in some of or all modes or sets as required by the actual embodiment:
display a document shown on my laptop on the TV screen;
playback music and video files from my iPad;
connect a storage media e.g. a USB device to the system;
copy files from a connected USB storage device;
the user may store personal scene settings;
one iPad to be used as a master and another other one as a slave;
go to an internet page;
search in YouTube videos;
play an iPad game on the TV screen;
load and execute MS Windows applications;
load and execute Android applications;
load and execute Apple IOS applications
intercommunication and phone,
GPS position services.

A wide range of different types of media files can be played back on the system, for example: Audio-CD (CDDA), SVCD and VCD (Video CD/CDXA) video, DVD-Video directly from Harddisk-drive or network, Blu-ray directory (partial), longest video loan modification only, no menus, requires libbluray, linux only, MPEG, MPG, M2V formats (inc. VCD's .dat and .bin and DVD's .vob), MPEG-TS (TY/TS/DV) DVB transport stream format, M2T/M2TS/MTS (Blu-ray and AVCHD video format) container #5, M2TS (Blu-ray video format) container #5, EVO (Enhanced VOB) HD DVD video format container #5, MP4 (MPEG-4 video) container, LATM (Low-overhead MPEG-4 Audio Transport Multiplex) for AAC audio only, RIFF AVI (AVI 1.0) container, OpenDML AVI (AVI 2.0) container #1, BivX (AVI with several audio streams) container. Microsoft ASF/ASX/WMV/WMA containers #5, Microsoft DVR-MS (Windows Media Center) containers #1/#5, QuickTime QT/MOV containers #5, FLV and SWF (Adobe/Macromedia Flash Video) containers, NUT multimedia container, AVS (Audio Video Standard) audio/video containers, Nullsoft Steaming Video (NSV) containers #1, Nullsoft Steaming Audio (NSA) containers, MPA, MP2, MP3 and WAV containers #5, AAC, M4A, MP4 (MPEG-4 audio) audio containers #5, RealMedia (Real Video/Audio) RM/RAM/RA/RV/RMVB containers #1, OGG, OGA, OGM, and OGV containers, Matroska (MaTpëwka) MKV containers #1, VIVO (VIV) containers, PVA containers, NuppelVideo containers, FLI and FLC containers,

Tracker Mods (18 formats supported) audio, M3U, PLS, CUE, URL, and STRM audio/video playlist and bookmark support#1.

A wide variety of image/video formats may be played/illustrated: CBR/CBZ, BMP, JPG/JPEG, GIF, ICO, PCX, PNG, RAW, TIF/TIFF, TGA.

In the following, a preferred embodiment of the invention will be described with reference to the drawing, wherein:

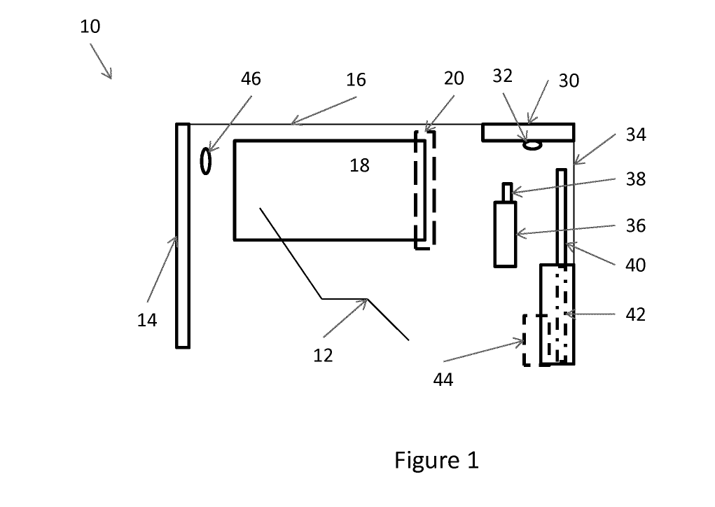

FIG. 1 illustrates a vehicle according to an embodiment of the invention and

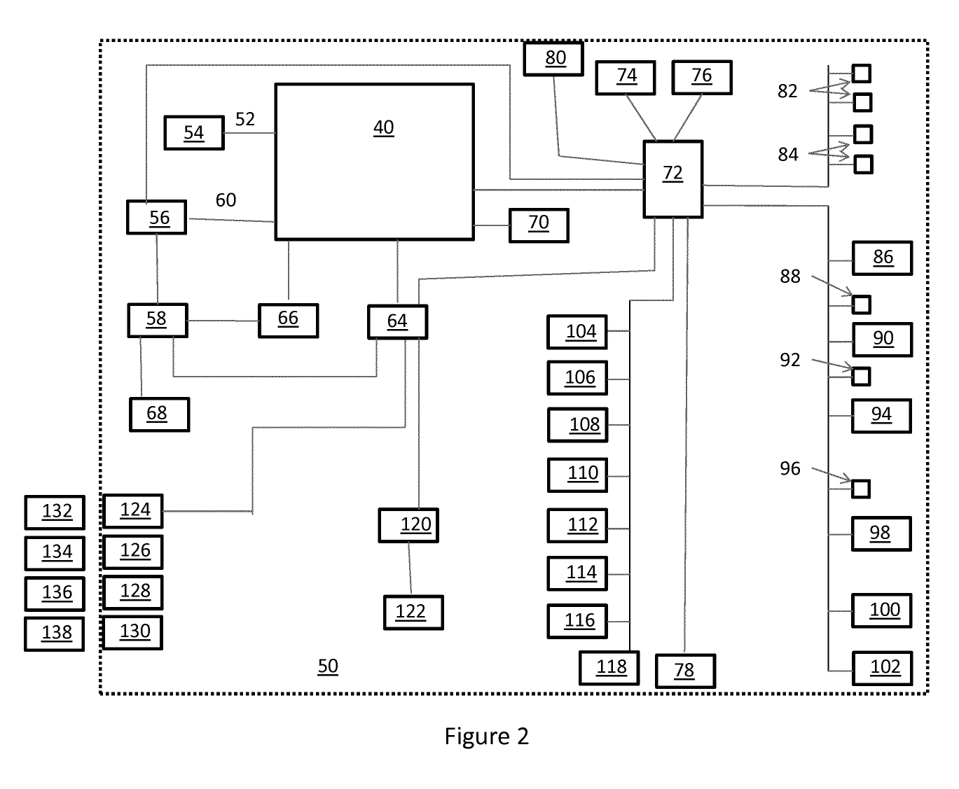

FIG. 2 is a functional block diagram of a preferred system for use in the vehicle according to FIG. 1.

FIG. 1 illustrates a closed compartment 10, which may be a passenger compartment of a car or other vehicle, a bus, a van, an airplane or a ship/vessel.

The compartment 10 comprises a chair 12 having controllable parameters, such as position, height, back-leaning angle, heating, vibration/massage, foot rest position, and the like.

The compartment also has a back wall 14, a ceiling window 16, a ceiling 30, a front window 34 and a side window 18, where the windows 16, 18 and 34 have a controlled tinting degree. This tinting may be as that seen in high end vehicles, such as tintable rear view mirrors and the like.

Provided is also curtains 20 which may be in addition to or as an alternative to the tintable windows.

The compartment has cabin lights 46 and ceiling lights 32, which are also controllable.

A TV 40 is provided which has an upper, active position and a lower position 42, where the TV is hidden in a console, whereby the front window 34 is (more) visible.

Also provided is a speaker 36 which has an acoustical lens 38 which has a controlled illumination. Finally, a subwoofer 44 is provided which has a forward (extended), active position and a retracted, inactive position, and which has a controlled illumination.

FIG. 2 displays a functional block diagram of a preferred system 50 embodiment as implemented in a compartment as that seen in FIG. 1. The system comprises a TV 40, such as a BeoVision 10, connected via a HDMI connection 52 to a video distributor (WiDi) 54 comprising an antenna in order to provide a wireless video signal.

The TV 40 is connected, via an ML connection 60 to a ML gateway, B&O control unit 56, powered by a 240Vac input, and which communicates with a switch 58 over an Ethernet connection 62.

The switch 58 communicates, via an Ethernet connection, with a PC Media center 64 and, via another Ethernet connection, with an Apple TV box 66. The Media center 64 and the TV box 66 each communicate with the TV 50 over HDMI connections.

The switch 58 furthermore communicates, via an Ethernet connection, with a WLAN UMTS wireless router 68 having a WiFi antenna and potentially a GSM antenna external to the system 50.

The TV 40 is positioned on a BeoLab 11 turnbase 70 for rotation thereof. This turnbase 70 is connected to and controlled by the TV 40.

A Platform 3 amplifier 72 receives 5.1 surround sound signals from the TV 40 and communicates with the control unit 56 over an RS232 link. The amplifier 72 receives signals from a front microphone 74 and rear microphones 76. The amplifier 72 outputs signals to a dual earphone connection 80 and a power on/off signal to/from a power supply 78 receiving 12Vdc and outputting 240Vac.

The amplifier 72 outputs signals to a number of speaker pillars, a B pillar L/R lens 82 and a C pillar L/R lens 84 as well as lens light. The amplifier 72 is fed a 12Vdc signal.

In addition, the amplifier 72 feeds signals to a Beolab 11 subwoofer 86, B-pillar speakers, Lens L/R 88, midrange L/R and C, 90, Tweeter C, 92, Woofer L/R 94, C-pillar speakers: Lens L/R 96, Midrange L/R 98 as well as woofer L/R 100 and D-pilllar speakers: midrange L/R and C, 102.

A CAN controller 118 transmits signals to seats 104, Front window tinting 106, side window tinting 108, subwoofer lighting 110, cabin light controls 112, ambient light controls 114, TV lift 116 as well as the amplifier 72.

The PC media center 64 receives 240Vdc power and is connected via USB to a camera videcon 120 and a mic. Telco 122.

External elements or controllers may be attached.

A HDD or Memory Stick 132 may be connected to a HDD connector or USB 2.0/3.0 connection 124 and to the PC media controller.

An iPhone or an iPod Touch 134 (with WiFi capability) may be connected to an iPhone doc connection comprising power 126.

An iPad 136 (with WiFi capability) may be connected to an iPad doc connection with power 128.

A laptop 138 (with WiFi capability) may be connected via a laptop connection with power 130.

The functions including:
Wirelessly attached control devices (e.g. iPhone 134, iPod Touch 134, iPad 136, Laptop 138).
An Internet connection via WLAN router and GSM.
A local network connection via B&O control unit Sand ML Gateway (B&O Master Link) 56 and an Ethernet switch 58).
Multimedia control center including TV set 40, HDMI sources (WiDi 68, PC Media Center 64, Apple TV 66).
Multimedia sources/files residing on the Internet, CTV broadcast (terrestrial, satellite).
Sound amplification 72 and providing loudspeakers (acoustical lens, subwoofer, loudspeakers) 82-102.
Inter communication means like camera 120, microphones 122, 74, 76 and headsets and earphones.
Comfort utilities (adjust seats 104, adjust windows 106, 108, adjust lights 110-116, turning and lifting TV set 116, 70 and loudspeakers).
Support means like power supply 78, bus controllers 118.

Comments to the comfort utilities:
The temperature of the seats may be regulated via the control system.
The adjustment of seat positions may be regulated via the control system.
The seat has a massage function to be controlled.
The color (tint) of the windows may be regulated; this acts as an electronic controlled curtain.

The invention as disclosed may be applied in closed compartments in vehicles, in cars, in boats, in air planes, in houses, in office buildings and in any place where an advanced work place with integrated utilities is needed and required for the comfort and benefit of the user.

### Embodiments

1. An integrated control system to be applied in a closed compartment in a vehicle or in a boat, or in an air plane, the control system characterized by having included access to data and control of:

a. multimedia information sources,

b. local server resident multimedia information sources,

c. light sources,

d. comfort equipment,

e. one or more sound providers (loudspeakers),

f. one or more video providers (screens),

g. system functions is via a Scene modes selection commanded from an interactive man-machine-device control device (e.g. iPad).

2. An integrated control system according to embodiment 1, where specific Scene modes relate to different combinations of settings, the Scene modes being one or more of: Office, Concert, Cinema, Basic, Internet, Relax.

3. An integrated control system according to embodiment 2, where the settings include controllable elements, the elements being one or more of: Front window, Side windows, Seats, Cabin light, Roof light, Ambient light, Loudspeaker light, TV screen, Audio provider, Loudspeaker, Subwoofer, Subwoofer light.

4. An integrated control system according to embodiment 3, where a Scene mode is entered via user activation on an interactive man-machine-device, the control being a physical push button, or the control being a touch sensitive area on a physical device, or the control being a gesture sensitive device.

5. An integrated control system according to embodiment 3, where a Scene mode is entered via user activated control, the control being a spoken command.

6. An integrated control system according to embodiment 3, where a Scene mode is entered via user activated control, the control being via a pointing device.

7. An integrated control system according to embodiment 6, where the user activation is a single event as the trigger of one or more events that brings the system from a current Scene mode to a new Scene mode and correspondingly establishes all the settings related to the new Scene mode.

1. A vehicle, a boat or an airplane comprising a closed compartment, a multimedia information source and a control system, wherein:
the closed compartment comprises:
controllable light sources,
controllable comfort equipment,
one or more sound providers and
one or more video providers,
the control system comprises a control device configured to receive an instruction and output controlling information to the light sources, the comfort equipment, the sound provider(s) and the video provider(s), the instruction identifying a set of a plurality of sets, each set comprising a setting for the controllable light sources, the controllable comfort equipment, the one or more sound providers and the one or more video providers.

2. A vehicle, a boat or an airplane according to claim 1, wherein the controllable light sources comprises one or more of: a cabin light, a roof light, ambient light, loudspeaker light and subwoofer light.

3. A vehicle, a boat or an airplane according to claim 1, wherein the controllable comfort equipment comprises one or more of: a front window with controllable tinting, one or more side windows with controllable tinting, controllable curtains, and one or more seats with controllable settings.

4. A vehicle, a boat or an airplane according to claim 1, wherein the one or more sound providers comprises: an audio provider, one or more loudspeakers and one or more subwoofers.

5. A vehicle, a boat or an airplane according to claim 1, wherein the one or more video providers comprises one or more TV screens.

6. A vehicle, a boat or an airplane according to claim 1, wherein the control device comprises one or more of the group consisting of: a physical push button, a touch sensitive area on a physical device, a gesture sensitive device, and a pointing device.

7. A vehicle, a boat or an airplane according to claim 1, wherein the control device is configured to receive, as the instruction, a spoken command.

8. A vehicle, a boat or an airplane according to claim 1, wherein the control system is configured to connect to the internet.

9. A vehicle, a boat or an airplane according to claim 1, wherein the compartment comprises one or more controllable seats, a front window with a controllable tinting, one or more side windows with controllable tinting, a controllable cabin light, a controllable roof light, controllable ambient light, one or more loudspeakers each comprising an acoustical lens with controllable illumination, a TV screen movable between an active and an inactive position, and a sub-woofer movable between an active and an inactive position and with a controllable illumination.

10. A vehicle, a boat or an airplane according to claim 9, wherein one set comprises the following parameters:
front window tinting: 100%,
side window tinting: 50%,
seats are adjusted to a first pre-adjusted setting,
cabin light intensity: 100%,
roof light: maximum illumination,
ambient light intensity: maximum illumination,
lens light intensity: maximum illumination,
TV screen: active position,
sub-woofer: inactive position,
sub-woofer light intensity: off.

11. A vehicle, a boat or an airplane according to claim 9, wherein one set comprises the following parameters:
front window tinting: 33%,
side window tinting: 33%,
seats are adjusted to a second pre-adjusted setting,
cabin light intensity: 40%,
roof light: minimum illumination,
ambient light intensity: maximum illumination,
lens light intensity: maximum illumination,
TV screen: active position,
sub-woofer: active position,
sub-woofer light intensity: maximum illumination.

12. A vehicle, a boat or an airplane according to claim 9, wherein one set comprises the following parameters:
front window tinting: 100%,
side window tinting: 100%,
seats are adjusted to a third pre-adjusted setting,
cabin light intensity: 10%,
roof light: minimum illumination,
ambient light intensity: 10% illumination,
lens light intensity: low illumination,
TV screen: active position,
sub-woofer: active position,
sub-woofer light intensity: 10% illumination.

13. A vehicle, a boat or an airplane according to claim 9, wherein one set comprises the following parameters:
front window tinting: 0%,
side window tinting: 70%,
seats are adjusted to a third pre-adjusted setting,
cabin light intensity: 60%,
roof light: maximum illumination,
ambient light intensity: 50% illumination,
lens light intensity: high illumination,
TV screen: inactive position,
sub-woofer: active position,
sub-woofer light intensity: 50% illumination.

14. A vehicle, a boat or an airplane according to claim 9, wherein one set comprises the following parameters:
front window tinting: 100%,
side window tinting: 100%,
seats are adjusted to a fourth pre-adjusted setting,
cabin light intensity: 100%,
roof light: off,
ambient light intensity: 100% illumination,
lens light intensity: high illumination,
TV screen: active position,
sub-woofer: active position,
sub-woofer light intensity: 100% illumination.

15. A vehicle, a boat or an airplane according to claim 9, wherein one set comprises the following parameters:
front window tinting: 100%,
side window tinting: 100%,
seats are adjusted to a fifth pre-adjusted setting,
cabin light intensity: 33%,
roof light: minimum illumination,
ambient light intensity: 33% illumination,
lens light intensity: high illumination,
TV screen: active position,
sub-woofer: inactive position,
sub-woofer light intensity: off.
